(19) United States
(12) Patent Application Publication
(10) Pub. No.: US 2011/0187185 A1
(43) Pub. Date: Aug. 4, 2011

(54) ELECTRIC TRACTION CHAIN FOR AN AUTOMOBILE

(75) Inventor: Philippe Dupuy, Fourqueux (FR)

(73) Assignee: Renault S.A.S., Boulogne-Billancourt (FR)

(21) Appl. No.: 13/056,318

(22) PCT Filed: Jul. 3, 2009
(86) PCT No.: PCT/FR2009/051299

§ 371 Date: Apr. 21, 2011

(30) Foreign Application Priority Data
Jul. 28, 2008 (FR) 0855175

(51) Int. Cl. B60L 11/18

(52) U.S. Cl. 307/10.1

(57) ABSTRACT

The invention relates to an electric traction chain (1) for an automobile, including:—an onboard rechargeable power source (2); —a static converter (5) capable of generating a three-phase voltage system connected by input to said rechargeable power source (2); a three-phase electric motor (10) supplied with power by the three-phase voltage system generated by the static converter (5); and wherein an external electric power source (35) is connectable to the stator windings of the motor to enable recharging of the onboard power source across the static converter (5). The electric traction chain is characterized in that the motor (10) is synchronous with separate excitation, for which the power supply to the rotor (23) is cut off during the recharging phases.

### FIELD OF THE INVENTION

The invention relates to the field of automobiles, and more particularly vehicles that include an electric traction chain.

It is aimed more specifically at the particular arrangements used to improve the recharging time of the electric storage battery delivering the traction power.

### PRIOR ART

Generally, the vehicles that include an electric traction chain comprise a storage battery engineered to deliver the power needed for the traction function. This battery powers an electric motor via a solid-state converter. The role of these converters is to generate a system of alternating voltages, advantageously three-phase, which are directly applied to the motor. This type of converter therefore operates as an inverter, and therefore delivers a system of voltages, the amplitude and frequency of which are controlled to deliver the required torque.

One problem that has already been identified regarding vehicles with electric traction chains relates to the recharging phase of the storage batteries. Compared to heat engine vehicles, the energy recharging phase is much longer. In fact, with the currently known techniques, the vehicle has to be immobilized for a time of around an hour or longer, in order to power the onboard battery via a mains voltage source. Generally, the recharging of the batteries is done by connecting said batteries to a charger which may be internal or external. With the type of onboard converters currently available, these recharging operations may take several hours, so they are usually performed at night, when the vehicle is stopped.

There are, moreover, external chargers that provide for much faster recharging operations, but which are too expensive to enable them to be widely deployed. Furthermore, these specific charger types are not always compatible with the very wide variety of terminal blocks that are found in electric vehicles.

A solution has already been proposed by the document EP-0 603 778 to handle recharging of the storage batteries. The principle involves connecting an external electric power source to the terminals of the stator windings of the motor. This way, the windings of the motor act as inductive components, and the inverter to which they are connected functions as a switched-mode converter to recharge the battery.

A latent problem presented by this solution lies in the generation of a motor torque when the recharging current passes through the stator windings, during the battery recharging phases. In practice, the magnet synchronous motors or the asynchronous motors used in this solution offer the advantage of not requiring any current supply for the rotating parts, but on the other hand they present the drawback of generating a torque when their stator windings are passed through by a three-phase alternating current. The existence of this torque, even low when the rotor is immobilized, constitutes a particular drawback because, in the event of impact, however light, during the charging, this average torque delivered to the wheels by the motor increases very significantly and will be all the greater if the charging current circulating in the machine windings is high. In fact, the slightest movement of the rotor in the direction of the stator rotating field linked to the passage of the charging current will cause a torque to be generated in the same direction, because of an overspeed caused by a pulling into synchronism of the rotor and stator fields with the disastrous consequence of the unwanted starting of the vehicle.

It will therefore be understood that there is a risk of seeing the vehicle move unexpectedly. This risk is all the more dangerous since, for an electric vehicle, the idle speed does not exist, the vehicle being perfectly silent at zero speed. In practice, it is not possible to differentiate a vehicle that is actually stopped and a vehicle at zero speed but ready to accelerate if the accelerator pedal is depressed. Also, it is absolutely essential to ensure, by a radical means, that a vehicle that is parked does not present any risk of restarting. For this, the regulations provide for the electric system to be provided with a cut-off device ensuring that no traction is possible in this state. Such is not the case in the system described in the document EP-0 603 778, which recommends immobilizing the vehicle by locking the wheels of the vehicle using the braking system. This solution is not at all satisfactory, because it does not satisfy the current regulations that consist in providing an electric cut-off of the traction system when the vehicle is stopped. Also, it relies only on the parking brake function as a safeguard when starting the vehicle, which is not sufficient to immobilize a vehicle when the traction engine is activated. Furthermore, when the wheels are blocked, all of the transmission between the engine output and the axles are the source of mechanical stresses and vibrations, notably at the power supply frequency of the external power source and at its harmonics.

The problem that the invention therefore sets out to resolve is to enable the storage battery to be recharged in an improved manner and notably by avoiding subjecting the mechanical transmission members to significant mechanical stresses and by eliminating any risk of non-zero average torque on the transmission shaft when charging.

### EXPLANATION OF THE INVENTION

The invention therefore relates to a traction chain for automobiles, comprising, as is known:
a rechargeable onboard energy source;
a solid-state converter, capable of delivering a system of three-phase voltages connected at the input to said rechargeable energy source;
a three-phase electric motor powered by the three-phase voltage system delivered by the solid-state converter;
   and in which an external electric energy source can be connected to the stator winding of the motor, to enable the onboard energy source to be recharged through the solid-state converter.

According to the invention, the traction chain is characterized in that the motor is of the synchronous type with separate excitation, for which the power supply for the rotor is interrupted during the recharging phases.

In other words, the motors used have a rotor which includes a winding which generates the rotor field with which the rotating field generated by the stator windings reacts. This excitation can be cancelled on command during a recharging phase, in order to cancel, or at least reduce very significantly, the torque generated by the current passing through the stator windings, during this same recharging phase. Thus, the constraint of having a rotor that has to be powered by rotating contacts is more than offset by the fact that the recharging of the battery can be done directly by connection to an external power supply network, three-phase in particular, but also single-phase, without generating significant mechanical stresses or presenting any risk of applying a non-zero average torque to the transmission at the output of the motor. In practice, each stator winding may include a pair of independent terminals, each winding having a terminal linked to the solid-state converter, the other terminal being alternately connected either to a neutral-forming common point, during the running phases, or to a terminal block for connection to the external energy source, during the charging phases. In other words, a winding of the stator of the motor is chosen that involves not directly linking the neutral of the three phases in the motor, but bringing the phase returns outside to be able to connect them to the external power source.

Advantageously, in practice, the traction chain may comprise a set of relaying members, electromechanical or electronic for example, capable of connecting the terminals of the stator windings to the common point, outside of the recharging phases. In other words, the neutrals can be connected inside or outside the machine by the closing of a set of relays shortcircuiting the phase returns.

In a variant embodiment, the traction chain may comprise a plug connector which itself forms the common point, capable of connecting the phase-return terminals of all the stator windings, outside of the recharging phases.

Conversely, during the recharging phases, the terminal block to which the phase-return terminals are linked may be linked to an external power source, either three-phase or single-phase. In the latter case, two of the stator windings are then connected together to the same terminal of the external power supply voltage source.

Depending on the cases in point, the terminal block may be linked to the external power source via a transformer, in particular a step-down transformer when a mains voltage power supply network is to be used.

### BRIEF DESCRIPTION OF THE DRAWINGS

How to implement the invention and the consequential benefits, will clearly emerge from the following description of the embodiments, supported by the appended figures in which:

FIG. 1 is a diagram illustrating the various component elements of the traction chain, shown in running mode;

FIG. 2 is a diagram similar to FIG. 1, showing a varying embodiment of the neutral of the motor;

FIGS. 3 to 6 are diagrams similar to FIG. 1, showing the traction chain in battery recharging modes, according to different variants of this external power source.

### DESCRIPTION OF THE EMBODIMENTS

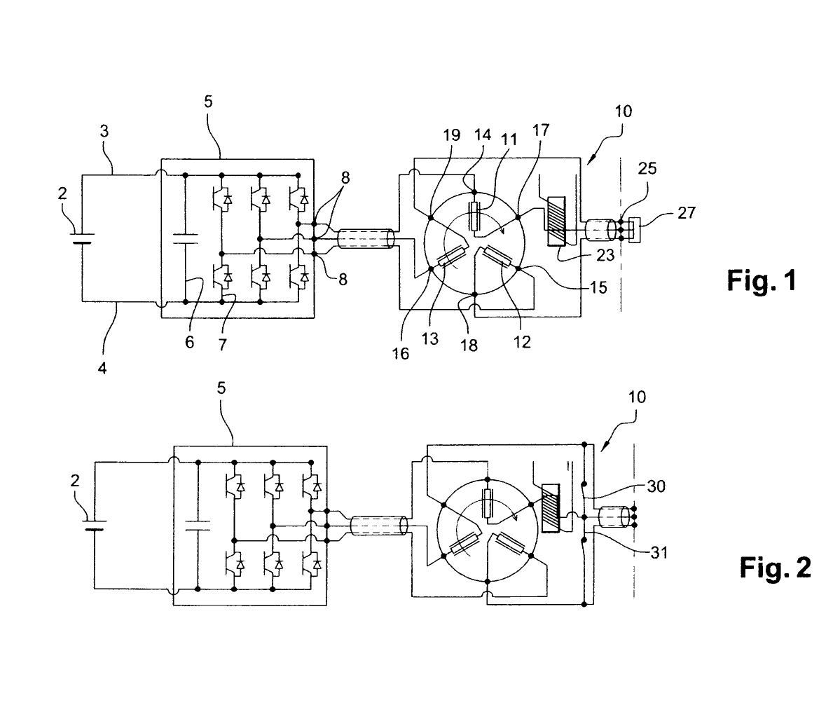

As illustrated in FIG. 1, the traction chain 1 mainly consists of a battery 2, the output terminals 3, 4 of which are linked to a solid-state converter 5 handling the inverter function. This inverter 5 includes an input capacitor 6 and various legs 7 each comprising two solid-state switches, between which the output terminals 8 are connected. When the inverter is controlled appropriately, the voltages present between the output terminals 8 form a system of three-phase voltages. This inverter 5 powers a motor 10 comprising three stator windings 11, 12, 13. The output terminals 8 of the inverter are linked to one of the terminals 14, 15, 16 of each stator winding 11, 12, 13. The phase-return terminals 17, 18, 19 of the stator windings 11, 12, 13 are themselves linked to a terminal block 25, to which the external power source will be linked.

In the embodiment illustrated in FIG. 1, the three phase-return terminals 17, 18, 19 of each stator winding are commoned via a plug connector 27.

The operation of the motor is assured by the appropriate power supply for the rotor winding 23 and appropriate control of the inverter 5.

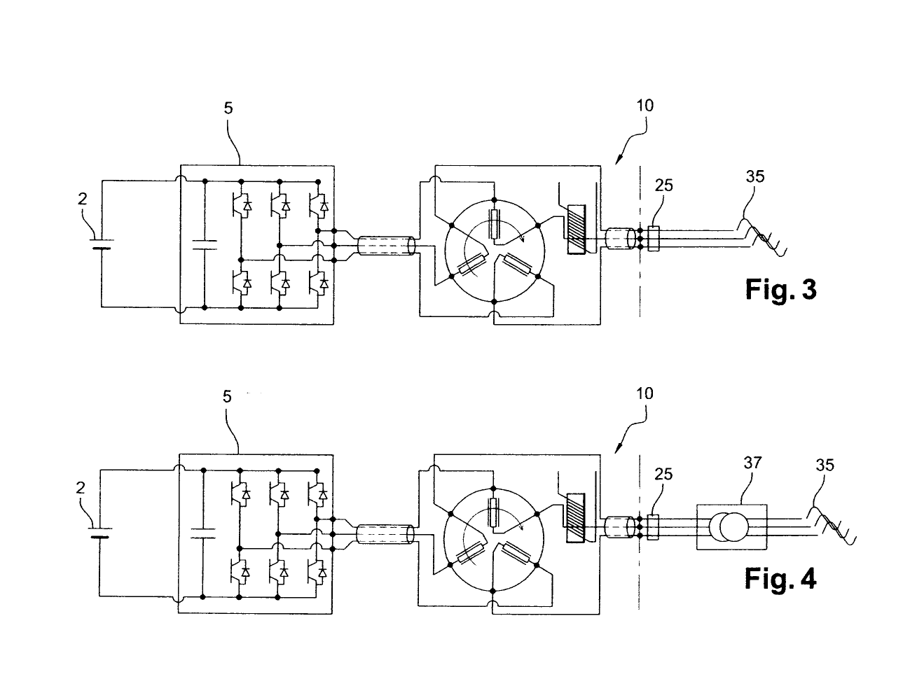

In the variant illustrated in FIG. 2, the different phase-return terminals 17, 18, 19 are commoned by the presence of two relays 30 and 31. The contacts of these relays 30, 31 are closed in running mode, in order to short-circuit the phase returns. On the other hand, the contacts of these relays are open in recharging mode. These relays may be produced using different technologies, with no impact on the principle of the invention.

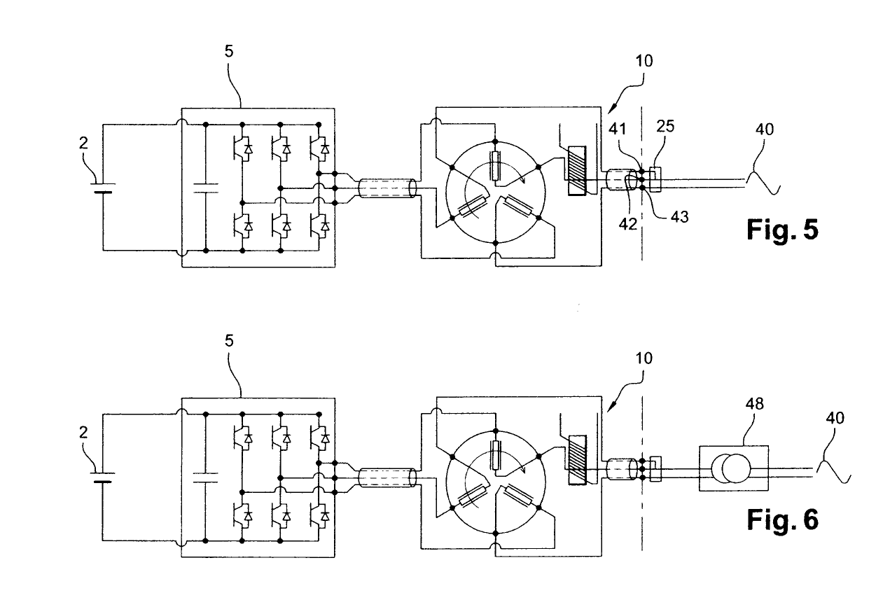

When the battery of the vehicle has to be recharged, the traction chain is configured as illustrated in FIG. 3. In this case, an external power source 35, preferably three-phase, is then linked to the terminal block 25. This way, with the rotor power supply being cut, the system of mains voltages 35 is applied via the stator windings acting as inductive elements to the output terminals 8 of the inverter. The inverter 5 then operates as a converter of the voltage step-up type, with the appropriate control of its constituent solid-state switches.

As appropriate, and as illustrated in FIG. 4, a step-down transformer 37 may be necessary to bring the voltage system applied to the stator of the motor to a level that allows the inverter to operate in voltage step-up mode.

The architecture of the traction chain according to the invention also allows, as illustrated in FIG. 5, the recharging from a single-phase mains voltage source. This recharging mode, although less rapid, may nevertheless be useful when the three-phase mains is not available.

In this case, the terminal block 25 is connected to the voltage source 40 so that two of its terminals 41, 42 are commoned, the third terminal 43 being connected to the other terminal of the power source 40. In this case, two of the stator windings 11, 13 are passed through by the same current.

As stated previously, the use of a step-down transformer 48 as illustrated in FIG. 6 may be necessary to enable the solid-state converter 5 to operate in voltage step-up mode.

From the above, it can be seen that the traction chain according to the invention presents the advantage of being able to be connected to a three-phase power source, without generating any torque within the motor during the recharging phase. Thus, the speed of charging when linked to a three-phase network is combined with safety of use compared to the prior art solutions. This architecture also allows recharging via a single-phase network.

1. An electric traction chain (1) for an automobile, comprising:
a rechargeable onboard energy source (2);
a solid-state converter (5), capable of delivering a system of three-phase voltages connected at the input to said rechargeable energy source (2);
a three-phase electric motor (10) powered by the three-phase voltage system delivered by the solid-state converter (5);
and in which an external electric energy source (35) can be connected to the stator windings of the motor, to enable the onboard energy source to be recharged through the solid-state converter (5), characterized in that the motor (10) is of the synchronous type with separate excitation, for which the power supply for the rotor (23) is interrupted during the recharging phases.

2. The electric traction chain as claimed in claim 1, characterized in that each stator winding (12, 13, 14) includes a pair of independent terminals, each winding having a terminal (14, 15, 16) linked to the solid-state converter, the other terminal (17, 18, 19) being alternately connected to a neutral-forming common point (27), or to a terminal block (25) for connection to the external electric energy source (35).

3. The electric traction chain as claimed in claim 1, characterized in that it comprises a set of relaying members (30, 31) capable of connecting the terminals of the stator windings to the neutral-forming common point, outside of the recharging phases.

4. The electric traction chain as claimed in claim 2, characterized in that it comprises a plug connector (27) forming the common point capable of connecting the terminals (17, 18, 19) of all the stator windings (12, 13, 14), outside of the recharging phases.

5. The electric traction chain as claimed in claim 4, characterized in that the terminal block (25) is linked to a three-phase external power source (35).

6. The electric traction chain as claimed in claim 4, characterized in that the terminal block (25) is linked to a single-phase external power source, two of the stator windings (41, 42) being commoned to the same terminal of the external power source (40).

7. The electric traction chain as claimed in claim 4, characterized in that the terminal block (25) is linked to the external power source via a step-down transformer (37).
